(19) United States
(12) Patent Application Publication
(10) Pub. No.: US 2025/0375788 A1
(43) Pub. Date: Dec. 11, 2025

(54) Sprinkler Head Anti-sink Bracket

(71) Applicant: Jeffrey Votava, Parker, CO (US)

(72) Inventor: Jeffrey Votava, Parker, CO (US)

(21) Appl. No.: 18/735,152

(22) Filed: Jun. 5, 2024

(51) Int. Cl. B05B 15/60

(52) U.S. Cl. CPC B05B 15/60

(57) ABSTRACT

The sprinkler head anti-sink bracket is designed to prevent underground sprinkler heads from sinking below the ground surface. This is a common problem that is difficult to resolve. These brackets are easy to install at the time of original installation of the sprinkler system and can be easily installed later as well. The brackets include an open space design with spikes that will create significant friction to prevent the sprinkler heads from sinking.

### PRIOR ART

U.S. Pat. No. 6,152,651 Underground Sprinkler Elevating Apparatus and Method
U.S. Pat. No. 1,962,534 Lawn Sprinkling Means

### BACKGROUND OF THE INVENTION

A frequent problem of underground sprinkler systems is the tendency of sprinkler heads to gradually sink below the level of the grass or ground. As a result, the sprinkler spray can be obstructed. Repair involves raising the sprinkler head back to an acceptable level. As a significant layer of soil is above the connected sprinkler pipes, bringing the sunken sprinkler head up to the surface is often difficult. It frequently requires adding extended riser pipes in holes that might be filled with water and soil. Obviously, the simplest solution is to prevent the heads from sinking in the first place. That is the motivation for this invention.

### SUMMARY OF THE INVENTION

This invention is for a bracket that is designed to fit around common underground sprinkler heads to prevent the sprinkler heads from sinking in order to avoid costly sprinkler system repairs.

### BRIEF DESCRIPTION OF DRAWINGS

FIG. 1 illustrates an initial design implementation of the bracket that can be added to the sprinkler at installation time or at a later time.

FIG. 2 is a perspective view of a design implementation that illustrates the spikes in the open leaf design to increase friction and threads to allow simple bracket installation after the initial sprinkler system installation.

FIG. 3 show a threaded spacer that can be used to adjust the height above ground level for the sprinkler head.

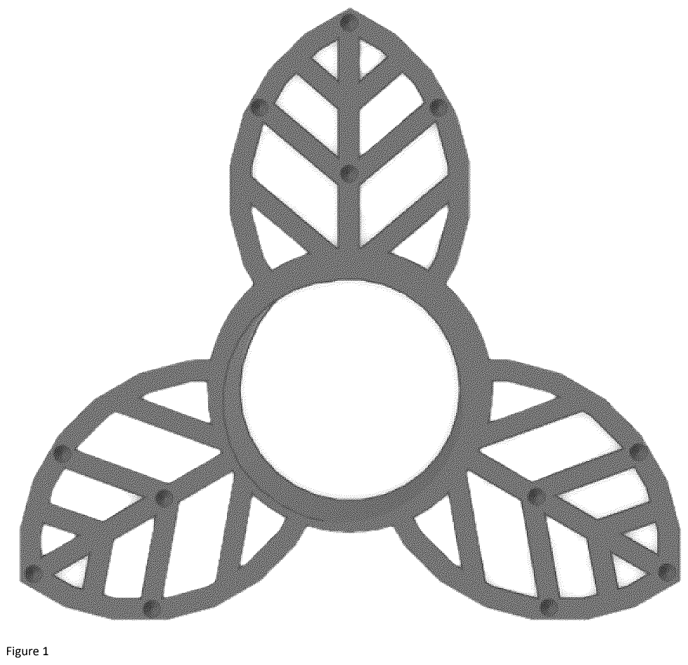

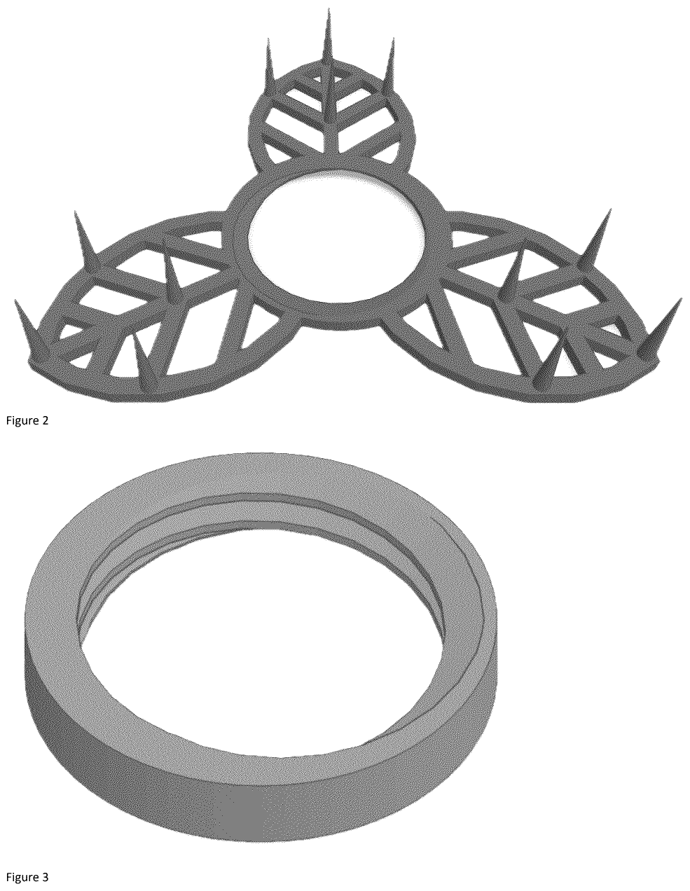

### DETAILED DESCRIPTION OF THE INVENTION

The sprinkler anti-sink bracket is designed to fit around sprinkler heads in such a way that the top of the sprinkler head cannot pass through the bracket. The bracket extends laterally outside of the sprinkler head to engage with the ground surface. It includes open spaces in the design that allow grass or other plants to grow through the bracket. This allows for natural vegetation growth and increases the holding power of the bracket. Additionally, spikes are included on the bracket “leaves” to add friction.

As a design feature, the bracket is designed with leaf-shaped extensions. These extensions provide the necessary friction to prevent the sprinkler head from sinking. The brackets can also be made in any color to blend in with soil, vegetation or other ground features.

The bracket is designed to slip easily onto the sprinkler head prior to installation of the sprinkler system. However, the inside of the bracket is also threaded or designed in two pieces so that it can be easily added to an underground sprinkler system that is already installed.

1. An add-on bracket that can be attached to an underground sprinkler system sprinkler head such that the attachment prevents or resists the natural tendency of the sprinkler head to sink over time.

2. The attachment in claim #1 such that the attachment can easily be slid onto a sprinkler head prior to underground installation.

3. The attachment in claim #1 such that the attachment can be easily added from the top after the sprinkler is already installed underground.

4. The attachment in claim #1 such that the attachment is designed to look like a plant with one or more leaves. The leaf design includes open space that allows grass roots or other plants to grow through the attachment in order to provide additional resistance to sinking.

5. The attachment in claim #1 such that the attachment includes spikes in order to better grip the surrounding soil.

6. An additional ring bracket of differing diameters and heights such that it can be used to adjust the space between the top of the sprinkler head and the vertical position of the bracket surface of claim #1.

7. An additional secured sleeve attached to the bracket of claim #1 of differing diameters and heights such that it can be used to surround the sprinkler head to protect the sprinkler head from soil and vegetation.
